(19) United States
(12) Patent Application Publication
(10) Pub. No.: US 2011/0032979 A1
(43) Pub. Date: Feb. 10, 2011

(54) IMAGE DISPLAY CONTROL DEVICE AND IMAGING DEVICE PROVIDED WITH THE IMAGE DISPLAY CONTROL DEVICE, IMAGE PROCESSING DEVICE AND IMAGING DEVICE USING THE IMAGE PROCESSING DEVICE

(75) Inventors: Yoshihiro MATSUO, Gifu City (JP); Shigeyuki Okada, Ogaki City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/852,023

(22) Filed: Aug. 6, 2010

(30) Foreign Application Priority Data
Aug. 7, 2009 (JP) 2009-184930
Aug. 7, 2009 (JP) 2009-184931
Jul. 13, 2010 (JP) 2010-158913

(51) Int. Cl. H04N 11/04; G06K 9/00

(52) U.S. Cl. 375/240.01; 382/103; 375/E07.026

(57) ABSTRACT

A decoding unit decodes coded data produced by a coding device capable of coding a captured video both in a first image quality and a second image quality different from the first image quality, or of coding the video in one of the first image quality and the second image quality. A display control unit displays the video of the first image quality or the video of the second image quality, as decoded by the decoding unit, on a display device. When both the coded data of the first image quality and the coded data of the second image quality are available, the display control unit displays information, indicating that the video currently displayed can be displayed in the other image quality, in a screen of the display device.

This application is based upon and claims the benefit of priority from the prior Japanese Patent Applications No. 2009-184930, filed on Aug. 7, 2009, Japanese Patent Application No. 2009-184931, filed on Aug. 7, 2009, and Japanese Patent Application No. 2010-158913, filed on Jul. 13, 2010, the entire contents of which are incorporated herein by reference.

### BACKGROUND OF THE INVENTION

1. Field of the Invention

The present invention relates to an image display control adapted to decode coded image data and displaying the image on a predetermined display device, and to an imaging device provided with the image display control device. The present invention also relates to an image processing device adapted to code captured videos and an imaging device provided with the image processing device.

2. Description of the Related Art

Recently, digital camcorders that allow casual users to shoot a video have become widely available. Some camcorders are capable of capturing full HD (1920×1080) videos. Videos captured by such digital camcorders are used for various purposes. For example, videos may be viewed on a television or a PC, attached to an e-mail message and transmitted, or uploaded to a video sharing site, a blog site, or an SNS site on the Internet.

Videos captured at the full HD resolution are of high quality and are suitably viewed on a high-vision TV. However, data for videos captured at the full HD resolution will be voluminous and are not suitable for attachment to and transmission via e-mail messages or for uploading to a site on the Internet. For example, many of video sharing sites, blog sites, and SNS sites impose restriction on the volume of video image uploaded.

Therefore, for uploading to a site on the Internet, videos captured at the full HD resolution need be imported into a PC and converted into videos at a lower resolution and/or a lower frame rate to reduce its volume. The higher the quality of the original videos, the longer it takes to convert the videos, requiring a user to perform a time-consuming task.

One approach to address this is to code videos of a plurality of different image quality levels in parallel at imaging and to produce a plurality of video files of different image quality levels. For example, two encoders may be provided in a digital camcorder so that two video files of different image quality levels are produced. When coded data of a plurality of different image quality levels are produced, the volume of video files as a whole will be larger than in the case when a single type of coded data is produced.

### SUMMARY OF THE INVENTION

The image display control device according to an embodiment of the present invention comprises: a decoding unit configured to decode coded data produced by a coding device capable of coding a captured video both in a first image quality and a second image quality different from the first image quality, or of coding the video in one of the first image quality and the second image quality; and a display control unit configured to display the video of the first image quality or the video of the second image quality, as decoded by the decoding unit, on a display device. When both the coded data of the first image quality and the coded data of the second image quality are available, the display control unit displays information, indicating that the video currently displayed can be displayed in the other image quality, in a screen of the display device.

Another embodiment of the present invention relates to an imaging device. The device comprises: an imaging unit configured to capture a video; a coding device capable of coding the video captured by the imaging unit both in the first image quality and the second image quality, or of coding the video in one of the first image quality and the second image quality; the aforementioned image display control device; and a display device subject to display control by the display control device.

The image processing device according to an embodiment of the present invention comprises: an image coding unit capable of coding a captured video both in a first image quality and a second image quality different from the first image quality, or of coding the video in one of the first image quality and the second image quality; and a control unit configured to direct the image coding unit to code the video both in the first image quality and the second image quality during a first period that meets a predetermined condition, and direct the image coding unit to code the video in one of the first image quality and the second image quality during a second period that does not meet the predetermined condition.

Another embodiment of the present invention relates to an imaging device. The imaging device comprises: an imaging unit configured to capture; and the aforementioned image processing device configured to process the video captured by the imaging unit.

Optional combinations of the aforementioned constituting elements, and implementations of the invention in the form of methods, apparatuses, systems, recording mediums and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the configuration of an imaging device provided with a processing device according to the first embodiment;

FIG. 2 shows a relation between a frame image supplied to the branch unit, a frame image coded by the first image coding unit, and a frame image coded by the second image coding unit;

FIG. 3 shows the timing of switching between a single codec mode, in which the video is coded in the HD image quality, and a dual codec mode, in which the video is coded in the HD image quality and the SD image quality;

FIG. 4 shows the timing of switching between a single codec mode, in which the video is coded in the SD image quality, and a dual codec mode, in which the video is coded in the HD image quality and the SD image quality;

FIG. 5 shows the configuration of imaging device provided with the processing device according to the second embodiment;

FIG. 6 shows an example of setting an area of interest;

FIG. 7 shows the configuration of an image display system provided with an image display control device according to the third embodiment;

FIGS. 8A and 8B show the first example of displaying the image quality information;

FIG. 8A shows image quality information indicating that the video can be displayed in the SD image quality, and FIG. 8B shows image quality information indicating that the video can be displayed in the HD image quality;

FIG. 9 shows the second example of displaying the image quality information;

FIGS. 10A-10C show examples of displaying image quality information accompanying trigger information;

FIG. 10A shows an example of displaying the image quality information accompanying trigger information indicating that user operation is the trigger condition; FIG. 10B shows an example of displaying the image quality information accompanying trigger information indicating that the sound signal level exceeding the threshold value is the trigger condition; and FIG. 10C shows an example of displaying the image quality information accompanying trigger information indicating that the detection of an object is the trigger condition;

FIG. 11 shows the configuration of the imaging device provided with the processing device according to the variation; and

FIG. 12 shows an elaborated version of the example of FIG. 2 based on the variation.

### DETAILED DESCRIPTION OF THE INVENTION

The invention will now be described by reference to the preferred embodiments. This does not intend to limit the scope of the present invention, but to exemplify the invention.

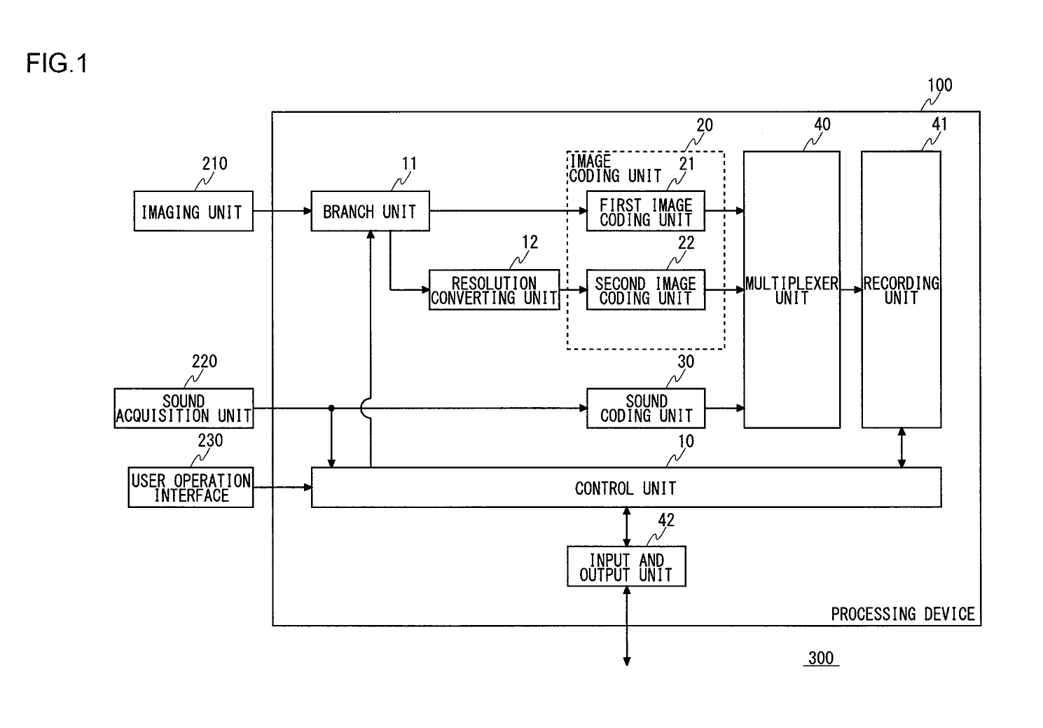

FIG. 1 shows the configuration of an imaging device 300 provided with a processing device 100 according to the first embodiment. The imaging device 300 comprises an imaging unit 210, a sound acquisition unit 220, a processing device 100, and a user control interface 230.

The imaging unit 210 captures frame images in succession and supplies a resultant video to the processing device 100. The imaging device 210 is provided with a solid-state imaging device (not shown) such as a charge coupled device (CCD) sensor and a complementary metal oxide semiconductor (CMOS) image sensor, and a signal processing circuit (not shown) for processing a signal output from the solid-state imaging device. The signal processing circuit is capable of converting analog R, G, B signals output from the solid-state imaging device into a digital luminance signal Y and color difference signals Cr, Cb.

The sound acquisition unit 220 converts sound acquired from an external source into an electric signal and outputs the resultant sound signal to the processing device 100 (more specifically, to a control unit 10 and a sound coding unit 30 in the processing device 100).

The processing device 100 primarily processes videos captured by the imaging unit 210. The processing device 100 includes a control unit 10, a branch unit 11, a resolution converting unit 12, an image coding unit 20, a sound coding unit 30, a multiplexer unit 40, a recording unit 41, and an input and output unit 42. The image coding unit 20 includes a first image coding unit 21 and a second image coding unit 22.

The configuration of the processing device 100 is implemented by hardware such as a processor, memory, or other LSIs and by software such as a program or the like loaded into the memory. FIG. 1 depicts functional blocks implemented by the cooperation of hardware and software. Therefore, it will be obvious to those skilled in the art that the functional blocks may be implemented in a variety of manners by hardware only, software only, or a combination of thereof.

The branch unit 11 outputs the video supplied from the imaging unit 210 to the first image coding unit 21, or the resolution converting unit 12, or both, in accordance with an instruction designated by a control signal from the control unit 10.

The resolution converting unit 12 converts the resolution of frame images forming the video supplied from the branch unit 11. It will be assumed that the resolution converting unit 12 lowers the resolution of the frame images. The resolution converting unit 12 may reduce the resolution by cropping an area at the center of the frame image and removing the surrounding area. Alternatively, the unit 12 may lower the resolution by down-sampling pixels within the frame image. The resolution converting unit 12 outputs the video formed by the frame images subjected to resolution conversion to the second image coding unit 22.

The image coding unit 20 is capable of coding the video captured by the imaging unit 210 in the first image quality and in the second image quality different from the first image quality, in parallel or simultaneously. In other words, the image coding unit 210 is capable of subjecting a single type of video to dual codec coding. Referring to FIG. 1, the first image coding unit 21 is capable of coding the video supplied from the branch unit 11, and the second image coding unit 22 is capable of coding video supplied from the resolution converting unit 12 in parallel or simultaneously.

The video of the first image quality and the video of the second image quality are coded at different resolutions. An extensive variety of combinations of the resolution of the video of the first image quality and the resolution of the video of the second image quality will be possible. For example, any two of the pixel sizes 1920×1080, 1280×720, 640×480, 448×336, and 192×108 may be used in combination.

Further, the video of the first image quality and the video of the second image quality may be coded at different frame rates as well as being coded at different resolutions. For example, any two of the frame rates 60 fps, 30 fps, and 15 fps may be used in combination. Alternatively, a high frame rate such as 240 fps or 600 fps may be assigned to low resolutions such as 448×336 pixel size and 192×108 pixel size.

The image coding unit 20 subjects the video of the first image quality and the video of the second image quality to compression coding according to a predetermined standard. For example, the unit 20 is capable of compression coding according to a standard such as H.264/AVC, H.264/SVC, MPEG-2, and MPEG-4.

The image coding unit 20 may code the video of the first image quality and the video of the second image quality in a time-divided manner using a single hardware encoder or using a software process on a general-purpose processor. Alternatively, the unit 20 may code the video of the first image quality and the video of the second image quality in parallel using two hardware encoders. The image coding unit 20 outputs coded data (also referred to as a coded data stream) for the video of the first image quality and code data for the video of the second image quality to the multiplexer unit 40.

The sound coding unit 30 codes a sound signal supplied from the sound acquisition unit 220. For example, the unit 30 subjects the signal to compression coding according to a standard such as AAC or MP3. The sound coding unit 30 outputs the coded data for the sound to the multiplexer unit 40.

The multiplexer unit 40 multiplexes the coded data for the video of the first image quality supplied from the first image coding unit 21, the code data for the video of the second image quality supplied from the second image coding unit 22, and the coded data for the sound supplied from the sound coding unit 30 so as to produce a single video file. For example, the unit 40 is capable of producing a container file conforming to the MP4 file format. The container file can contain a container describing header information, meta data, or time information of the coded data. By allowing the decoding end to refer to the container file, synchronization between the video of the first image quality, the video of the second image quality, and the sound is facilitated and random access is facilitated.

The recording unit 41 records the video file multiplexed by the multiplexer unit 40 in a recording medium. At least one of a built-in memory and a detachable removable memory may be used as a recording medium. For example, a semiconductor memory or a hard disk may be employed as a built-in memory. A memory card, removable hard disk, or optical disk may be employed as a removable memory.

The input and output unit 42 communicates with an external device via a predetermined interface. For example, the unit 42 may be connected to a PC or an external hard disk using a USB cable to transfer the video file recorded in the recording medium to the PC or the external hard disk. Alternatively, the unit 42 may be connected to a television using a D terminal, S terminal, or HDMI terminal to display the video of the first image quality or the video of the second image quality on a television screen.

The user control interface 230 acknowledges a user instruction, generates a control signal based on the instruction, and outputs the control signal to the control unit 10. In this embodiment, a button dedicated to designating the use of a dual codec may be provided. In this case, the user can provide an instruction to start or end dual codec coding to the processing device 100, by pressing the button dedicated to designating the use of the dual codec.

The control unit 10 directs the image coding unit 20 to code the video both in the first image quality and the second image quality during a first period (hereinafter, referred to as a period of interest) that meets a predetermined condition and directs the image coding unit 20 to code the video in one of the first image quality and the second image quality during a second period (hereinafter, referred to as a period of non-interest) that does not meet the predetermined condition. Referring to FIG. 1, the control unit 10 transmits the control signal to the branch unit 11 to direct the unit 11 to output the video supplied from the imaging unit 210 to the first image coding unit 21, to the resolution converting unit 12, or to both.

The control unit 10 may determine at least one of the timing of start and the timing of end of the period of interest in accordance with a user instruction acknowledged by the user control interface 230. For example, when the dedicated button is pressed in a single codec mode in which the captured video is coded in one of the first image quality and the second image quality, the control unit 10 initiates transition to a dual codec mode in which the video is coded in both the first image quality and in the second image quality. When the dedicated button is pressed in a dual codec mode, the unit 10 initiates transition to a single codec mode.

The control unit 10 may start a period of interest when the sound signal level acquired from the sound acquisition unit 220 exceeds a predetermined threshold value. The point of time when the sound signal level exceeds the threshold value for a moment may be defined as the timing of start of the period of interest. The point of time when the threshold value is exceeded continuously for a predetermined period of time defined for determination of start may be defined as the timing of start of the period of interest.

The control unit 10 may end the period of interest when the sound signal level acquired from the sound acquisition unit 220 falls below the threshold value. The point of time when the level of the sound signal falls below the threshold value for a moment may be defined as the timing of end of the period of interest. The point of time when the threshold value fails to be reached continuously for a predetermined period of time defined for determination of end may be defined as the timing of end of the period of interest.

The threshold value may be set at a value based on an empirical rule obtained by a designer through experiments or simulation. Alternatively, the threshold value may be configured by the use as appropriate. The period of time defined for determination of start and the period of time defined for determination of end may also be user configurable. For example, provided that the threshold value is set at the sound level of ordinary human speech and the video of a person is shot at a quite place, the period of time when the person is talking may be defined as a period of interest, and the period of time when the person is silent may be defined as a period of non-interest.

Alternatively, provided that the threshold value is set at a high value and a sports game (e.g., baseball or football) is being captured in a video, a highlight scene of wild cheering may be defined as a period of interest and the other scenes may be defined as periods of non-interest.

The control unit 10 may use both of i) user-initiated transition to a dual codec mode or return to a single codec mode, and ii) transition initiated by sound recognition. For example, both functions may simply be activated. In this case, in the event of occurrence of the depression of the dedicated button or of the sound signal level in excess of the threshold value during a single codec mode, transition to a dual codec mode is initiated. In the event of occurrence of the depression of the dedicated button or of the sound signal level falling below the threshold value during a dual codec mode, return to single codec mode is initiated.

One of the above functions may be used on a selective basis. For example, transition from a single codec mode to a dual codec mode may be initiated by the sound signal level exceeding the threshold level, and return from a dual codec mode to a single codec mode may be initiated by the depression of the dedicated button. The reverse configuration will also be possible.

A description will now be given of the operation of the processing device 100 according to the embodiment, using an example where the video of the first image quality comprises frame images of HD (1280×720) size, and the video of the second image quality comprises frame images of SD (640×480) size.

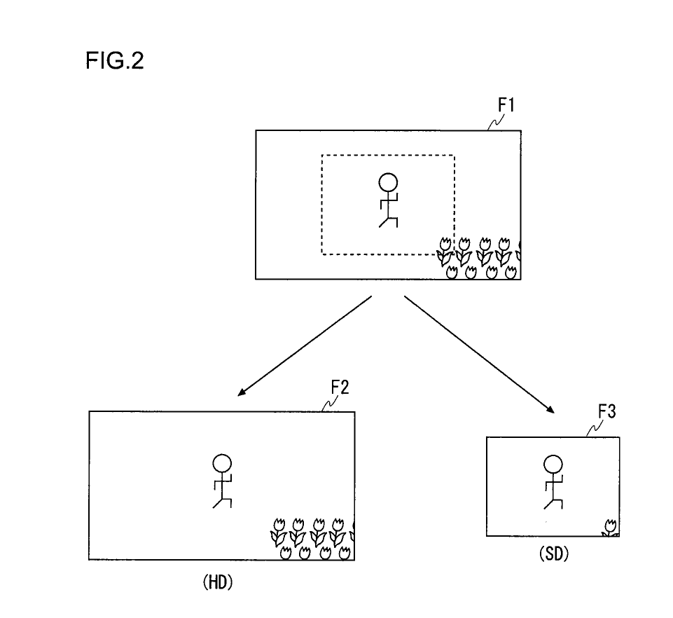

FIG. 2 shows a relation between a frame image F1 supplied to the branch unit 11, a frame image F2 coded by the first image coding unit 21, and a frame image F3 coded by the second image coding unit 22. In the above example, the frame image F1 of HD size is supplied to the branch unit 11. The frame images supplied to the processing device 100 from the imaging unit 210 may include areas for anti-blurring correction. It will be assumed that pixel data for areas for anti-blurring correction are cropped before being supplied to the branch unit 11.

The branch unit 11 outputs the frame image F1 of HD size to the first image coding unit 21 and the resolution converting unit 12. The resolution converting unit 12 converts the frame image F1 of HD size into the frame image F3 of SD size. The first image coding unit 21 directly codes the frame image F1 of HD size supplied from the branch unit 11. The second image coding unit 22 codes the frame image F3 of SD size supplied from the resolution converting unit 12.

The aspect ratio of the frame image F2 of HD size coded by the first coding unit 21 is 16:9, and the aspect ratio of the frame image F3 of SD size coded by the second coding unit 22 is 4:3. The frame image F3 of SD size is produced by leaving the central area of the frame image F2 of HD size and removing the surrounding area.

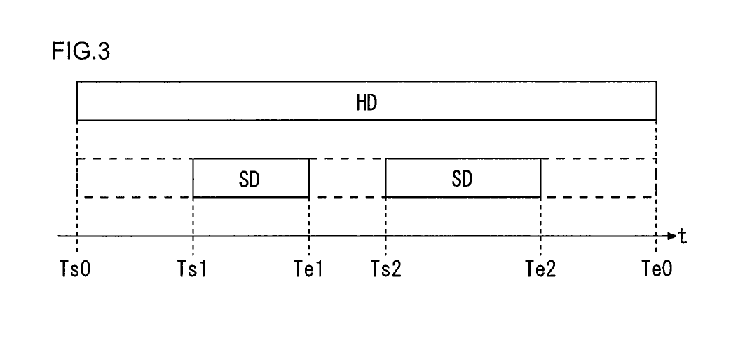

FIG. 3 shows the timing of switching between a single codec mode, in which the video is coded in the HD image quality, and a dual codec mode, in which the video is coded in the HD image quality and the SD image quality. In this example, the video of HD image quality is coded in the entire period of imaging, and both the video of HD image quality and the video of SD image quality are coded in a period of interest defined in the entirety of the imaging period. In other words, the image coding unit 20 codes the captured video in the HD image quality continuously and codes the video in the SD image quality intermittently.

This example is mainly suited to the purpose of storing high-quality videos for viewing on a PC or television and is secondarily suited to the purpose of attaching a selected scene of interest to an e-mail message for transmission or posting the scene on a site on the Internet. For example, the user can obtain SD image quality coded data for a scene that should be posted on a site on the Internet by pressing the dedicated button as the video is captured.

Referring to FIG. 3, two periods of interest are set in the entire period of imaging. Imaging is started at imaging start time Ts0 so that the video is started to be coded in the HD image quality using a single codec. Subsequently, the video is started to be coded in the HD image quality and in the SD image quality using a dual codec at time Ts1 when the first period of interest is started. Subsequently, coding of the video in the HD image quality and in the SD image quality is terminated at time Te1 when the first period of interest ends, so that coding of the video in the HD image quality using a single codec is started. Subsequently, the video is started to be coded in the HD image quality and in the SD image quality using a dual codec at time Ts2 when the second period of interest is started. Subsequently, coding of the video in the HD image quality and in the SD image quality is terminated at time Te2 when the second period of interest ends, so that coding of the video in the HD image quality using a single codec is started. Ultimately, imaging is terminated at imaging completion time TeO, so that coding of the video in the HD image quality using a single codec is terminated.

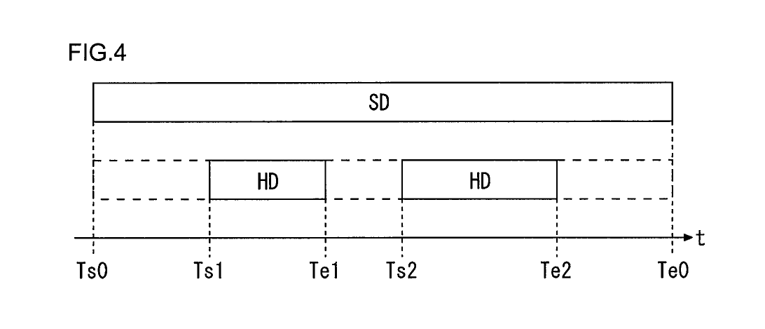

FIG. 4 shows the timing of switching between a single codec mode, in which the video is coded in the SD image quality, and a dual codec mode, in which the video is coded in the HD image quality and the SD image quality. In this example, the video of SD image quality is coded in the entire period of imaging, and both the video of HD image quality and the video of SD image quality are coded in a period of interest defined in the entirety of the imaging period. In other words, the image coding unit 20 codes the captured video in the SD image quality continuously and codes the video in the HD image quality intermittently.

This example is primarily suited to the purpose of attaching the entirety of the video to an e-mail message for transmission or posting the video on a site on the Internet and is secondarily suited to the purpose of storing a selected scene of interest for viewing on a PC or television. For example, the user can obtain HD image quality coded data for a scene that should be stored in a high image quality by pressing the dedicated button.

The description of the example of switching shown in FIG. 4 will be omitted because FIG. 4 shows the HD image quality and the SD image quality in the example of switching shown in FIG. 3 replaced by one another.

As described above, the first embodiment ensures that the video of a scene of interest is coded using a dual codec as it is being captured. The other scenes are subject to single codec coding. In this way, the necessity for transcoding of a video file is reduced while controlling an increase in the volume of a video file. In other words, the volume of a video file is reduced as compared with a case where the video is coded using a dual codec over the entire period of imaging. By producing coded data of two types of image quality for a scene of interest, the two types of coded data can be used to suit the purpose so that the frequency of transcoding is reduced.

By employing a configuration whereby the start and end of a period of interest can be designated by user operation, the period in which a dual codec is used can be set such that user preference is reflected. By employing a configuration whereby the start and end of a period of interest can be automatically set using sound recognition, the period coded in which a dual codec is used can be set without user intervention. Since the period of interest is set based on an objective event, failure to code a scene of interest using a dual codec due to a delay in user decision or an error in user operation is reduced.

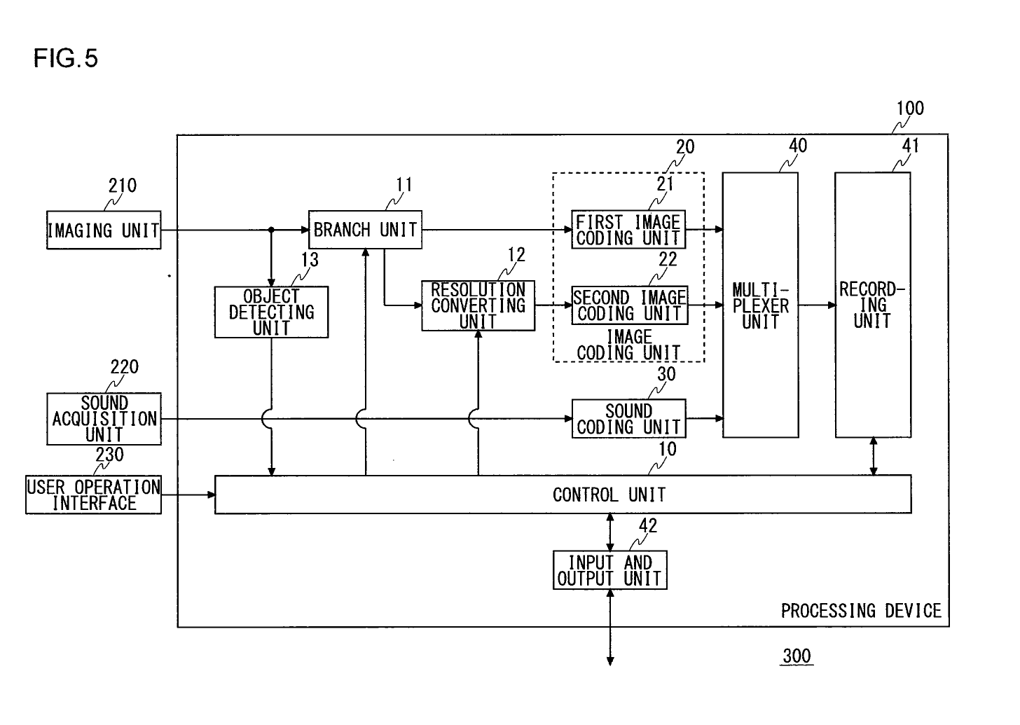

FIG. 5 shows the configuration of imaging device 300 provided with the processing device 100 according to the second embodiment. The processing device 100 according to the second embodiment is configured such that an object detecting unit 13 is added to the processing device 100 according to the first embodiment shown in FIG. 1. Hereinafter, description of those aspects of the second embodiment that are also found in the first embodiment will be omitted.

The video captured by the imaging unit 210 is supplied to the object detecting unit 13. The object detecting unit 13 detects a predetermined object from the frame image forming the video. For example, the object may be a face of a person. In this case, the object detecting unit 13 extracts a face of a person from the frame image using an ordinary face detection and tracking function. It will also be possible to detect the face of a specific person by producing an identifier for identifying the face of the specific person.

The object detecting unit 13 communicates the result of object detection to the control unit 10. More specifically, the unit 13 communicates whether an object is detected in the frame image forming the video, and the position of the detected object in the frame image, if the object is detected.

When an object is detected by the object detection unit 13, the control unit 10 starts a period of interest. When the object is no longer detected, the unit 10 terminates the period of interest. In other words, when an object is detected during a single codec mode, the control unit 10 initiates transition to a dual codec mode. When the object is no longer detected, the unit 10 initiates return to a single codec mode.

When transition is made to a dual codec mode as a result of detecting an object so that two types of coded data is produced as a result, the control unit 10 may produce one of the types of coded data by coding an area of interest in the frame image. For example, the control unit 10 may define an area of SD size including the object as an area of interest and direct the resolution converting unit 12 to crop the area of interest.

The control unit 10 may adaptively change the position of the area of interest in association with the movement of the object. The area of interest in the frame image may be set at a position where the area includes the object at its center. When the position of the area that should be cropped by the resolution converting unit 12 is changed, the control unit 10 designates, for each frame image, the position of the area of interest for the resolution converting unit 12. Alternatively, the control unit 10 may designate the position for the resolution converting unit 12 each time the position of the area of interest is changed.

The control unit 10 may use both of i) transition to a dual codec mode or return to a single codec mode initiated by detection of object, ii) and user-initiated transition. For example, both functions may simply be activated. In this case, in the event of occurrence of the depression of the dedicated button or of the appearance of an object during a single codec mode, transition to a dual codec mode is initiated. In the event of occurrence of the depression of the dedicated button or of the disappearance of an object during a dual codec mode, return to single codec mode is initiated.

One of the above functions may be used on a selective basis. For example, transition from a single codec mode to a dual codec mode may be initiated by the appearance of an object, and return from a dual codec mode to a single codec mode may be initiated by the depression of the dedicated button. The reverse configuration will also be possible.

The control unit 10 may use i) transition to a dual codec mode or return to a single codec mode initiated by the detection of an object, ii) user-initiated transition, and iii) transition initiated by sound recognition in combination.

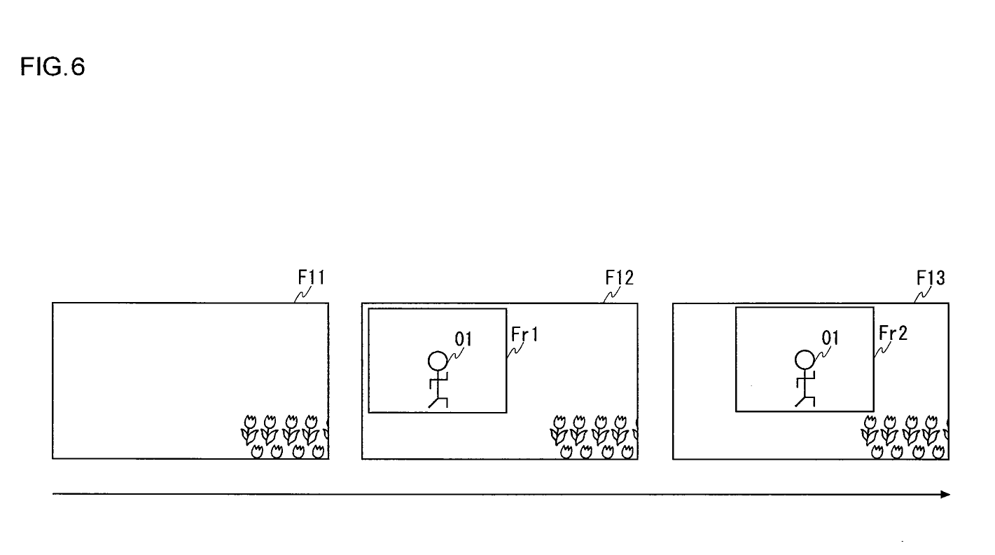

FIG. 6 shows an example of setting an area of interest Fr. FIG. 6 depicts three frame images forming a video (the first frame image F11, the second frame image F12, and the third frame image F13). The first frame image F11, the second frame image F12, and the third frame image F13 are arranged in the order of time. The first frame image F11 does not include an object. Therefore, the first frame image F11 is coded in a single codec mode.

The second frame image F12 includes an object O1 (in this case, a face of a person). Therefore, the second frame image F12 is coded in a dual codec mode. An area of interest Fr1 in the second frame image F12 is set around the object O1 and is set in the top left area of the second frame image F12.

The third frame image F13 also includes an object O1. Therefore, the third frame image F13 is also coded in a dual codec mode. An area of interest Fr2 in the third frame image F13 is set around the object O1 and is set in the top center area of the third frame image F13. FIG. 6 shows a person that should be captured running from left to right in the frame image forming the video. Therefore, the areas of interest Fr1 and Fr2 are also moved as the person moves.

As described above, the second embodiment provides the same advantage as the first embodiment. The second embodiment facilitates setting a period of time in which to use a dual codec without user intervention, by allowing the start and end of a period of interest to be set responsive to the detection of an object. Since the period of interest is set based on an objective event, failure to code a scene of interest using a dual codec due to a delay in user decision or an error in user operation is reduced. Of particular note, coded data can be produced only for scenes that capture a person, by defining the object to be a face of a person.

Of the two types of coded data, the low-resolution coded data may be produced by coding a variable area that includes an object instead of a fixed area in a frame image. In this way, it is ensured that coded data for the video that continues to capture the object can be produced. Further, by setting the position of the variable area at a position where the area includes the object at its center, coded data for the video that continues to capture the object at the center can be produced.

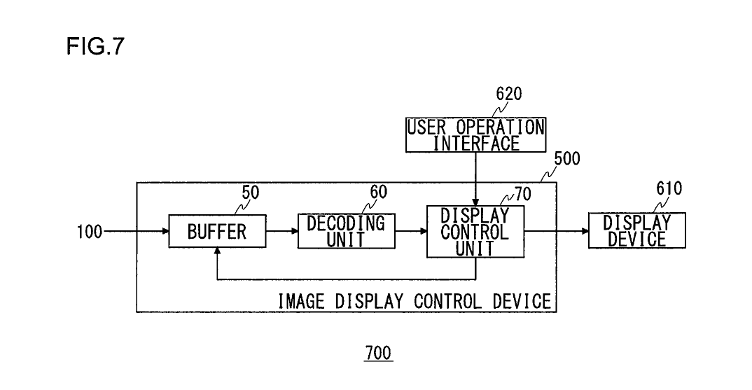

FIG. 7 shows the configuration of an image display system 700 provided with an image display control device 500 according to the third embodiment. The image display system 700 is provided with an image display control device 500, a display device 610, and a user operation interface 620.

Various hardware configuration may be used to form the image display system 700. For example, the image display system 700 may be built by the imaging device 300 and a television connected to the device 300 by cable. In this case, the image display control device 500 can be built using the control function of the imaging device 300. The user operation interface 620 can be built using the user operation function of the imaging device 300. The display device 610 can be built using the display function of the television.

The image display system 700 can be built using the PC receiving the video file produced by the processing device 100 according to the first or second embodiment. In this case, the image display control device 500, the user operation interface 620, and the display device 610 can be built using the control function, the user operation function, and the display function of the PC, respectively. The same is true of a case where a cell phone, a PDA, or a portable music player is used in place of a PC.

The image display system 700 can be built using the imaging device 300 described above. In this case, the image display control device 500, the user operation interface 620, and the display device 610 may be built using the control function, the user operation function, and the display function of the imaging device 300, respectively. The imaging device 300 includes the processing device 100 according to the first or second embodiment.

The image display control device 500 includes a buffer 50, a decoding unit 60, and a display control unit 70. The configuration of the image display control device 500 is implemented by hardware such as a processor, a memory, or other LSIs and by software such as a program or the like loaded into the memory. FIG. 7 depicts functional blocks implemented by the cooperation of hardware and software. Therefore, it will be obvious to those skilled in the art that the functional blocks may be implemented in a variety of manners by hardware only, software only, or a combination of thereof.

The buffer 50 temporarily stores the video file produced by the processing device 100 according to the first or second embodiment. The buffer 50 supplies the coded data for the video of the first image quality or the coded data for the video of the second image quality, which are included in the video file, to the decoding unit 60 in accordance with a control signal from the display control unit 70.

The decoding unit 60 decodes the coded data coded by the image coding unit 20 in the processing device 100 according to the first or second embodiment. More specifically, the decoding unit 60 decodes the coded data for the video of the first image quality or the coded for the video of the second image quality supplied from the buffer 50.

The user operation interface 620 acknowledges a user instruction, produces a control signal based on the instruction, and outputs the signal to the display control unit 70. In this embodiment, the unit 620 primarily acknowledges an instruction for playback of the video, and an instruction for displaying the video being displayed in a different image quality.

The display control unit 70 displays the video of the first image quality or the video of the second image quality decoded by the decoding unit 60 on the display device 610. The display control unit 70 displays the video on the display device 610 when the control signal generated in response to the instruction for playback is supplied from the user operation interface 620. In this process, the display control unit 70 determines the image quality of the video that should be displayed on the display device 610.

More specifically, when the image quality is designated by the user operation interface 620, the unit 70 determines on that image quality. When the image quality is not designated, the unit 70 determines on the image quality of one of the two types of coded data that is continuously coded. Since only one type of coded data is produced in a period of non-interest, determination is automatically made on the image quality of that coded data. When the display control unit 70 determines the image quality of the video that should be displayed on the display device 610, the image quality is indicated to the buffer 50.

During a period of time when both the coded data of the first image quality and the coded data of the second image quality are available (i.e., during the period of interest), the display control unit 70 displays information (hereinafter, referred to as image quality information) in the screen of the display device 610 to indicate that the video currently displayed can be displayed in another image quality. The image quality information may be displayed using a character string, symbol, icon, etc. The display control unit 70 can display the image quality information in the screen by superimposing the information on the frame image forming the video.

While the video of the first image quality is being displayed in the screen during the period of interest, the display control unit 70 displays image quality information in the screen to indicate that the video of the second image quality can be displayed. Meanwhile, while the video of the second image quality is being displayed in the screen, the unit 70 displays image quality information in the screen to indicate that the video of the first image quality can be displayed.

As described above, the video is coded in one of the first image quality and the second image quality continuously and coded in the other image quality intermittently. When displaying image quality information in the screen to indicate that the video can be displayed in the other image quality, the display control unit 70 displays information (hereinafter, referred to as trigger information) indicating a condition that triggered the activation of coding in the other image quality to accompany the image quality information.

The trigger information may be displayed to accompany the image quality information such that the trigger information is displayed near the image quality information. Alternatively, the image quality information and the trigger information may be displayed in a time-divided manner. Still alternatively, user operation may switch between displaying the image quality information and the trigger information.

Like the image quality information, the trigger information may be displayed using a character string, symbol, icon, etc. The display control unit 70 can display the trigger information in the screen by superimposing the trigger information on the frame image forming the video.

The trigger condition may be one of user operation, detection of an object in the frame image forming the video, and the sound signal level, acquired at imaging, exceeding the threshold value, which are described in the first and second embodiments. The display control unit 70 refers to subsidiary information related to the coded data and identifies the type of trigger condition. For example, the subsidiary information is described in the container file included in a video file, or described in the header of the first frame image in each segment of the intermittently coded video.

The type of trigger condition may differ for each segment of the intermittently coded video. Further, the condition triggering the start of a given segment may differ from the condition triggering the end thereof. In this case, the display control unit 70 displays both the start trigger information and the end trigger information to accompany the image quality information.

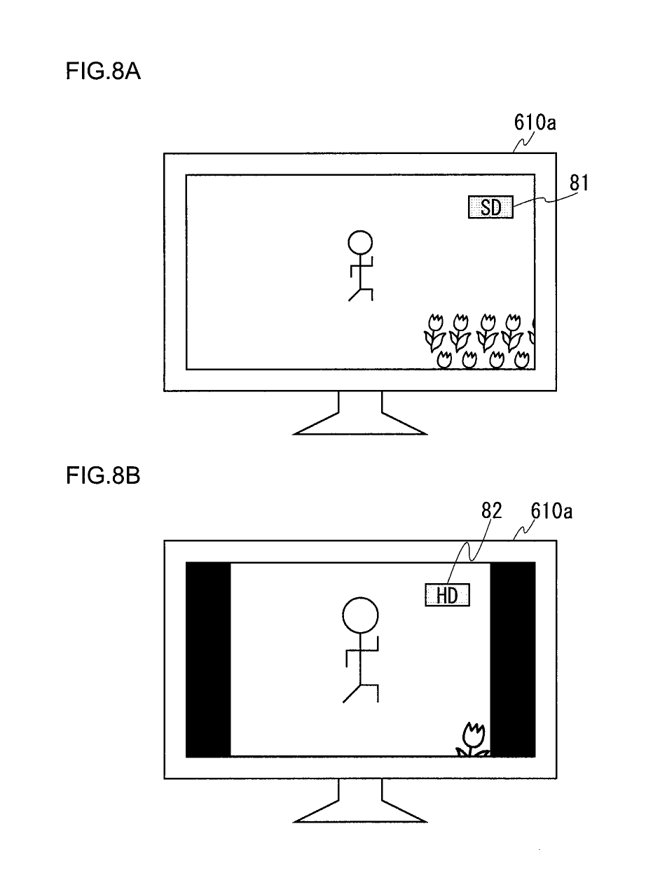

FIGS. 8A and 8B show the first example of displaying the image quality information. FIG. 8A shows image quality information 81 indicating that the video can be displayed in the SD image quality, and FIG. 8B shows image quality information 82 indicating that the video can be displayed in the HD image quality. The description below concerns an example where the video of the first image quality is a video formed by frame images of HD size, and the video of the second image quality is a video formed by frame images of SD size.

FIG. 8A shows that the video of the HD image quality is displayed on the display device 610 (in this case, a television 610a). In the period of interest, the image quality information 81 indicating that the video can be displayed in the SD image quality is displayed in the screen. The viewer can know from the image quality information 81 that the video currently displayed in the HD image quality can be displayed in the SD image quality. The viewer can switch to the display in the SD image quality by using the user operation interface 620. In the period of non-interest, the image quality information 81 is not displayed.

FIG. 8B shows that the video of the SD image quality is displayed on the television 610a. In the period of interest, the image quality information 82 indicating that the video can be displayed in the HD image quality is displayed in the screen. The viewer can know from the image quality information 82 that the video currently displayed in the SD image quality can be displayed in the HD image quality. The viewer can switch to the display in the HD image quality by using the user operation unit 620. In the period of non-interest, the image quality information 82 is not displayed.

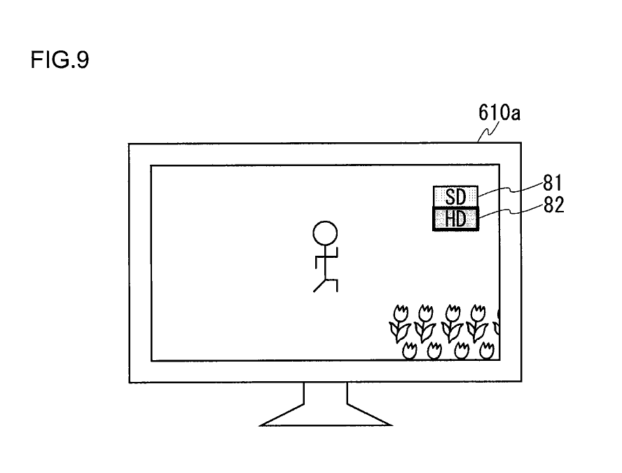

FIG. 9 shows the second example of displaying the image quality information. FIG. 9 shows that the video of the HD image quality is displayed on the television 610a. In this example, all image quality information, including information on the image quality in which the video is currently being displayed, is displayed. Referring to FIG. 9, the image quality information 81 indicating that the video can be displayed in the SD image quality, and the image quality information 82 indicating that the video can be displayed in the HD image quality are both displayed. The image quality of the video being displayed may be displayed in a mode recognizable by the viewer. In FIG. 9, the image quality of the video being displayed is the HD image quality so that the image quality information 82 indicating that the video can be displayed in the HD image quality is encircled by bold lines.

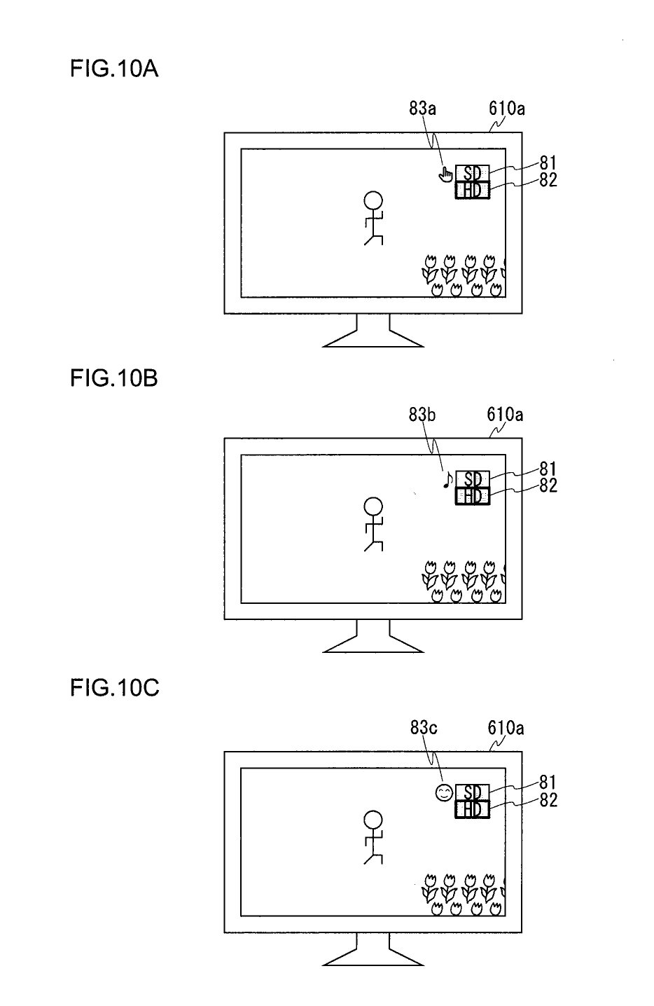

FIGS. 10A-10C show examples of displaying image quality information accompanying trigger information. FIG. 10A shows an example of displaying the image quality information 82 accompanying trigger information 83a indicating that user operation is the trigger condition. FIG. 10B shows an example of displaying the image quality information 82 accompanying trigger information 83b indicating that the sound signal level exceeding the threshold value is the trigger condition. FIG. 10C shows an example of displaying the image quality information 82 accompanying trigger information 83c indicating that the detection of an object is the trigger condition.

FIGS. 10A-10C show that the video of the HD image quality is displayed on the television 610a. FIG. 10A shows the trigger information 83a (in this case, a finger icon that reminds one of user operation) indicating that user operation is the trigger condition to the left of the image quality information 81 indicating that the video can be displayed in the SD image quality. FIG. 10B shows the trigger information 83b (in this case, a musical note icon that reminds one of sound recognition) indicating that sound signal level exceeding the threshold value is the trigger condition to the left of the image quality information 81 indicating that the video can be displayed in the SD image quality. FIG. 10C shows the trigger information 83c (in this case, a face icon that reminds one of face detection) indicating that face detection is the trigger condition to the left of the image quality information 81 indicating that the video can be displayed in the SD image quality.

As described above, the third embodiment offers improvement in viewer convenience experienced when displaying or playing back a video file produced by the processing device 100 according to the first or second embodiment. In other words, by displaying image quality information in the screen, the viewer can readily know whether the video can be displayed in the other image quality.

By displaying the trigger information to accompany the image quality information, the viewer can check the sensitivity of the function of transition to a dual codec mode initiated by sound recognition, and the function of transition to a dual codec mode initiated by the detection of an object. For example, the viewer can adjust the threshold value used in the function of transition to a dual codec mode initiated by sound recognition.

Described above is an explanation based on an exemplary embodiment. The embodiment is intended to be illustrative only and it will be obvious to those skilled in the art that various modifications to constituting elements and processes could be developed and that such modifications are also within the scope of the present invention.

For example, parallel coding of a captured video in two types of image quality is described by way of example in the first through third embodiments. Alternatively, a video may be encoded in parallel in three or more types of image quality. In this case, more image quality information will be displayed in the third embodiment.

In the first embodiment, the level of the sound signal acquired by the sound acquisition unit 220 in excess of the threshold value is used as the condition triggering transition to a dual codec mode. Alternatively, the amount of variation of the sound signal level in excess of a different predetermined threshold value may be used as the trigger condition.

The third embodiment is applicable to a video file coded using a dual codec over the entire period of imaging. In other words, the third embodiment is applicable to a video comprising only a period of interest. In this case, image quality information indicating that the video can be displayed in the other image quality will continue to be displayed.

Coding of the video of the first image quality and the video of the second image quality in different resolutions is described by way of example in the first through third embodiments. In the following variation, coding of the video of first image quality and the video of the second image quality in the same resolution and at different angles of view will be described by way of example.

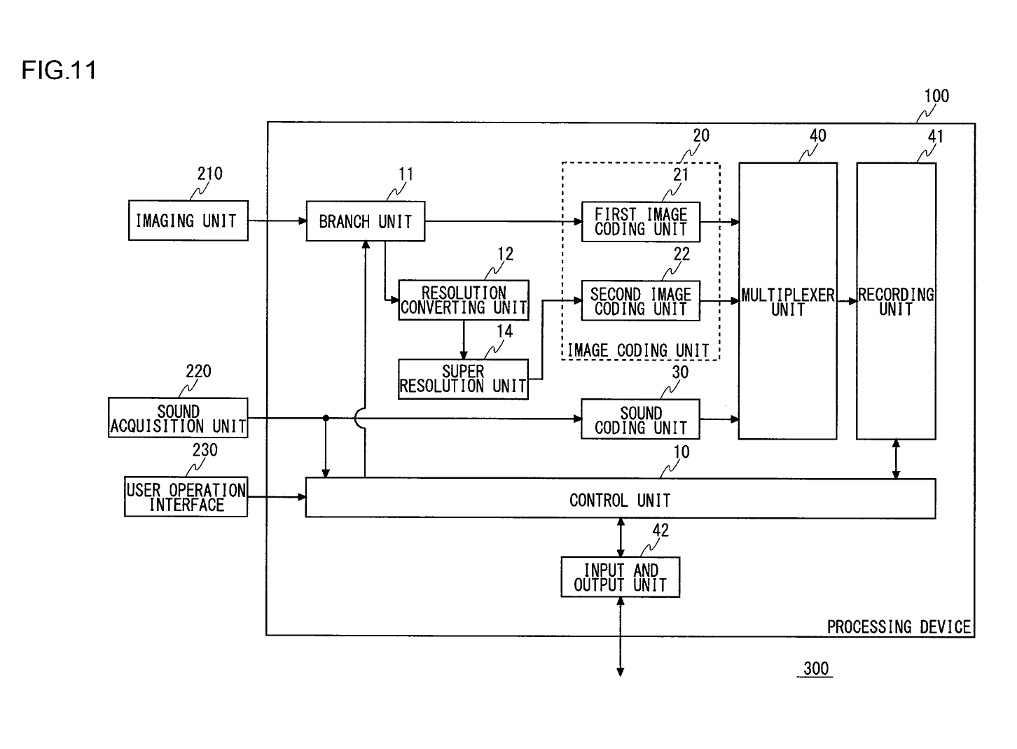

FIG. 11 shows the configuration of the imaging device 300 provided with the processing device 100 according to the variation. The processing device 100 of FIG. 11 is configured such that a super resolution unit 14 is added to the processing device 100 of FIG. 1. Hereinafter, the description given above with reference to FIG. 1 will not be repeated. The super resolution unit 14 uses the super resolution technique to improve the resolution of the frame image in which the resolution is lowered by the resolution converting unit 12. For super resolution reconstruction, known methods using intraframe process and/or interframe process may be employed.

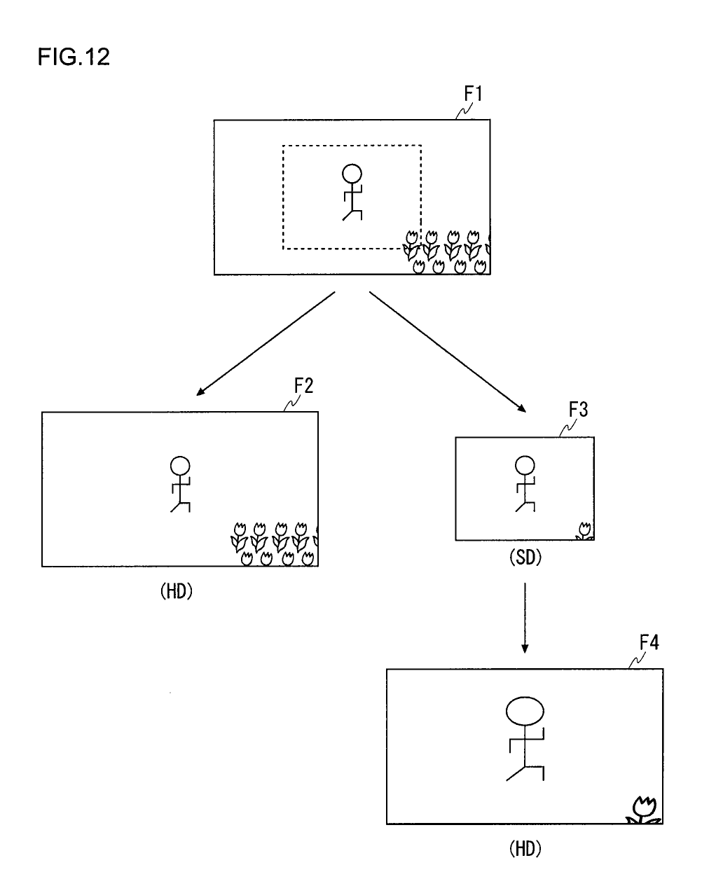

FIG. 12 shows an elaborated version of the example of FIG. 2 based on the variation described above. The frame image F1, the frame image F2, and the frame image F3 are as described with reference to FIG. 2. In this variation, the super resolution unit 14 transforms the frame image F3 into the frame image F4 of HD size. This will produce two frame images, namely, F2 and F4, having the same resolution and different angles of view.

The variations shown in FIGS. 11 and 12 are by way of example. The video of the first image quality and the video of the second image quality coded by the imaging device 300 using a dual codec shall not be of the same resolution and the same angle of view but only have to differ at least in the resolution and the angle of view. An extensive variation of the arrangement of the resolution converting unit 12 and the super resolution unit 14 will be possible to achieve this. For example, the resolution converting unit 12 and the super resolution unit 14 may be provided between the branch unit 11 and the first image coding unit 21 so as to adjust the resolution and angle of view of the video of the first image quality.

According to this variation, the specification of the video coded using a dual codec can be flexibly configured.

What is claimed is:

1. An image display control device comprising:
a decoding unit configured to decode coded data produced by a coding device capable of coding a captured video both in a first image quality and a second image quality different from the first image quality, or of coding the video in one of the first image quality and the second image quality; and
a display control unit configured to display the video of the first image quality or the video of the second image quality, as decoded by the decoding unit, on a display device,
wherein, when both the coded data of the first image quality and the coded data of the second image quality are available, the display control unit displays information, indicating that the video currently displayed can be displayed in the other image quality, in a screen of the display device.

2. The display control device according to claim 1,
wherein a period of capturing the video includes a first period when the video is coded both in the first image quality and in the second image quality, and a second period when the video is coded in one of the first image quality and the second image quality, and
the display control unit displays the video captured in the first period such that,
when the video of the first image quality is displayed in the screen, the display control unit displays information in the screen to indicate that the video of the second image quality can be displayed, and
when the video of the second image quality is displayed in the screen, the display control unit displays information in the screen to indicate that the video of the first image quality can be displayed.

3. The display control device according to claim 1,
wherein the video is coded in one of the first image quality and the second image quality continuously, and coded in the other of the first image quality and the second image quality intermittently, and
when displaying information in the screen to indicate that the video can be displayed in the other image quality, the display control unit displays information indicating a condition that triggered the coding in the other image quality such that the information indicating the trigger condition accompanies the information on the image quality.

4. The display control device according to claim 3,
wherein the trigger condition is one of user operation, detection of an object in the frame image forming the video, and a sound signal level, acquired at imaging, exceeding a threshold value, and
the display control unit refers to ancillary information related to the coded data so as to identify a type of the trigger condition.

5. An imaging device comprising:
an imaging unit configured to capture a video;
a coding device capable of coding the video captured by the imaging unit both in the first image quality and the second image quality, or of coding the video in one of the first image quality and the second image quality;
the image display control device according to claim 1; and
a display device subject to display control by the display control device.

6. An image processing device comprising:
an image coding unit capable of coding a captured video both in a first image quality and a second image quality different from the first image quality, or of coding the video in one of the first image quality and the second image quality; and
a control unit configured to direct the image coding unit to code the video both in the first image quality and the second image quality during a first period that meets a predetermined condition, and direct the image coding unit to code the video in one of the first image quality and the second image quality during a second period that does not meet the predetermined condition.

7. The image processing device according to claim 6,
wherein the control unit determine at least one of a timing of start and a timing of end of the first period in accordance with a user instruction acknowledged by the user control interface.

8. The image processing device according to claim 6,
wherein the control unit starts the first period when a sound level acquired from an external source exceeds a predetermined threshold value.

9. The image processing device according to claim 6, further comprising:
an object detecting unit configured to detect a predetermined object from a frame image forming the video,
wherein the control unit starts the first period when an object is detected by the object detection unit, and terminates the first period when the object is no longer detected.

10. An imaging device comprising:
an imaging unit configured to capture; and
the image processing device according to claim 6 configured to process the video captured by the imaging unit.
